(19) United States
(12) Patent Application Publication
(10) Pub. No.: US 2008/0250654 A1
(43) Pub. Date: Oct. 16, 2008

(54) Dual-use knife having a circular blade and a guide rod combined together

(76) Inventor: Pi-Chao Chang, Taichung County (TW)

Correspondence Address: Pi-Chao Chang, P.O. Box 44-2049, Taipei, 10668, TW

(21) Appl. No.: 11/783,903

(22) Filed: Apr. 13, 2007

(51) Int. Cl. B26B 29/06

(52) U.S. Cl. 30/292

(57) ABSTRACT

A dual-use knife having a circular blade and a guide rod combined together. When the rotatable circular blade is attached to a cloth-cutting guide rode a positioning cutting state of the stationary circular blade can be obtained so that the application range of the circular blade can be enlarged. In addition, the circular blade or the combination of the cloth-cutting guide rod and the circular blade can be positioned and operated on two sides of the knife so that the knife may be properly held by left and right hands. In addition, when the circular blade is combined with the guide rod, a circular blade upper cover can be rotated so that the position of the cutting point of the circular blade may be arbitrarily changed from 0 to 360 degrees, and a multi-function knife may be formed.

### BACKGROUND OF THE INVENTION

(1) Field of the Invention

The invention relates to a dual-use knife having a circular blade and a guide rod combined together, wherein the combination of the circular blade and the cloth-cutting guide rod may be used on two sides of a knife body of the knife. In addition, rotating a circular blade upper cover may change the angle of the circular blade from 0 to 360 degrees arbitrarily so that the effect of changing the position of the cutting point is obtained.

(2) Description of the Prior Art

The available knife has a handle to be held by the hand, a rotatable circular blade and a cutting device. The knife may cut a straight line or a circular shape in conjunction with a ruler or a cutting board with a special shape.

However, the typical knife is only suitable for the right hand of the user because the user has to monitor the cutting condition of the blade so as to control the cutting direction and the cutting force. If the user is used to use the left hand or a special condition occurs, the inconvenience tends to be caused and thus has to be improved.

In addition, the user has to use a clipper to cut a cloth at a portion between lines on the cloth. However, operating the clipper cannot achieve the quick speed and the high working efficiency, and two cut edges of the cloth tend to become uneven and cannot satisfy the effective effect and the glorification.

Furthermore, when the typical circular blade is used, the cutting surface of the blade cannot be easily replaced and tends to be damaged and broken. So, the user still has to purchase a new blade. Thus, the condition cannot satisfy the economic effect, and the drawback still has to be improved.

### SUMMARY OF THE INVENTION

In view of the drawbacks of the prior art circular blades of the knives, an object of the invention is to provide a dual-use knife according to the experience in manufacturing the associated products. The knife of the invention has a rotatable circular blade that may be combined with a cloth-cutting guide rod so that the application range of the circular blade can be enlarged.

Another object of the invention is to enable the circular blade or the combination of the circular blade and the cloth-cutting guide rod to be attached to two sides of a knife body according to the structural design so that the user may operate the knife correctly and smoothly with either the left hand or the right hand.

Still another object of the invention is to provide a knife having a blade that may be arbitrarily rotated to an angle from 0 to 360 degrees without disassembling the blade. Thus, the cutting point of the blade can be easily changed and the blade cannot deform due to the long term of use so that the convenience in use may be improved.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is a schematic illustration showing a structure of the invention.

FIG. 2 shows a used state of a right-hand cloth-cutting guide rod according to the invention.

FIG. 3 shows a used state of a left-hand cloth-cutting guide rod according to the invention.

FIG. 4 shows operations of a blade fixing wheel according to the invention.

FIG. 5 shows a used state of a safety device of the invention.

FIG. 6 shows an embodiment with a cloth-cutting guide rod.

FIG. 7 shows another embodiment without the cloth-cutting guide rod.

### DETAILED DESCRIPTION OF THE PREFERRED EMBODIMENTS

The structure, technological means and effect of the invention will be described with reference to the accompanying drawings according to the preferred embodiment of the invention.

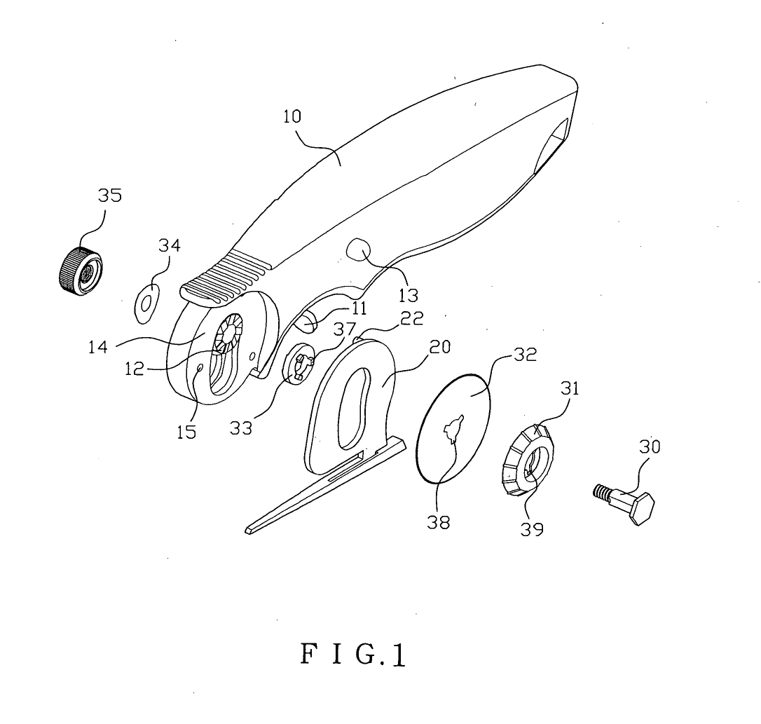

FIG. 1 is a schematic illustration showing a structure of the invention. Referring to FIG. 1, a dual-use knife of the invention includes a main body 10, a handle 11, a blade feeding rod 12 and a cutting device. The main body 10 has the structure that may be held by a hand properly. The cutting device includes a screw 30, a circular blade upper cover 31, a circular blade 32, a blade fixing wheel 33, a U-shaped washer 34 and a nut 35.

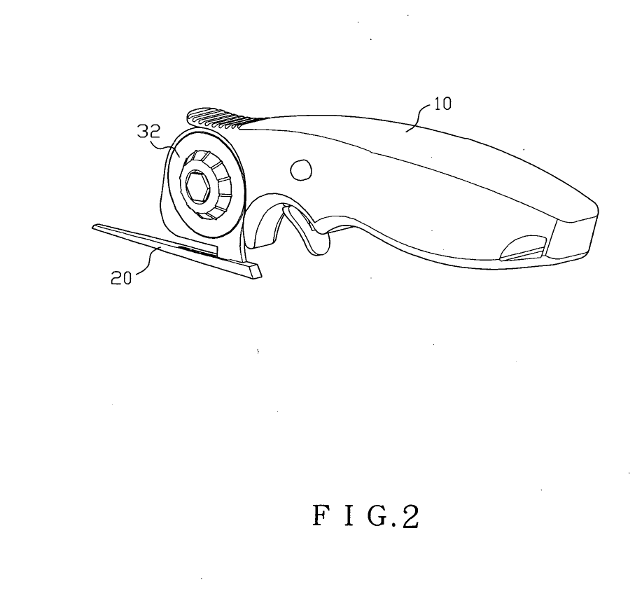

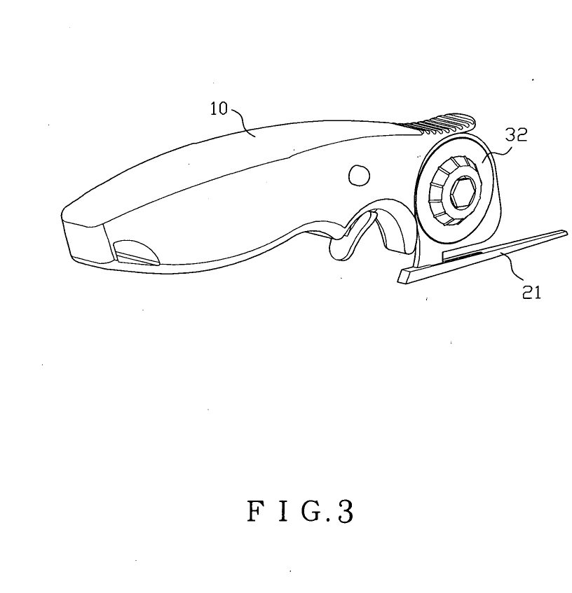

Please refer to FIGS. 1 to 3. As shown in FIG. 1, a cloth-cutting guide rod has a circular projection 22 inserted into a circular hole 15 of the main body 10. Two sides of the main body 10 are formed with circular holes 15 so that the user may replace the cloth-cutting guide rod on the left side and the right side. When the cloth-cutting guide rod is to be used for cutting, the cloth-cutting guide rod has to be placed between the circular blade 32 and the blade fixing wheel 33. In addition, as shown in FIG. 2, a right-hand cloth-cutting guide rod 20 and the cutting device may be placed on a left side of a knife body so that the user can clearly monitor the cutting condition and the travelling direction of the blade when he or she uses his or her right hand to operate the knife. Also, as shown in FIG. 3, a left-hand cloth-cutting guide rod 21 and the cutting device still may be placed on the right side of the knife body so that the user can see the rolling condition and the travelling direction of the blade when he or she uses his or her left hand to operate the knife. Thus, the knife may be properly held by the left and right hands.

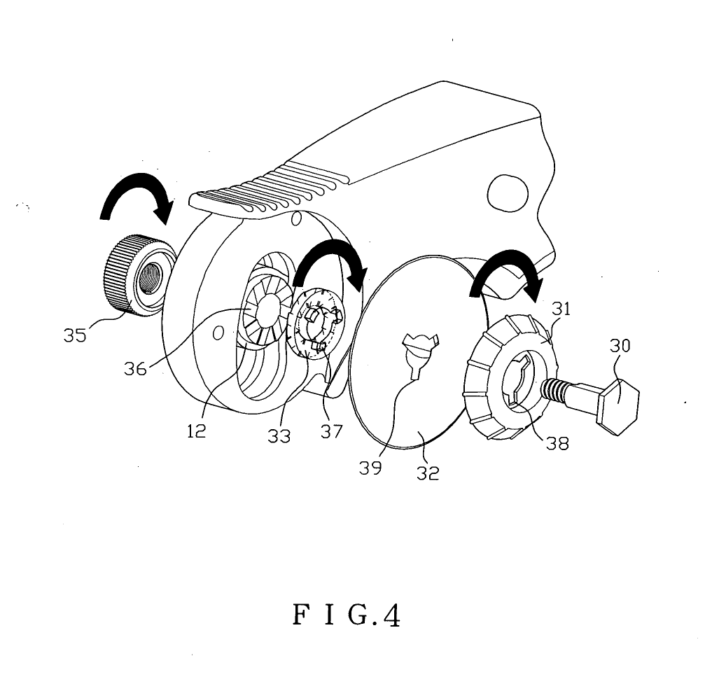

FIG. 4 shows operations of a blade fixing wheel according to the invention. As shown in FIG. 4, an engaging projection 37 on the blade fixing wheel 33 is combined with engaging slots 38 and 39 in the circular blade upper cover 31 and the circular blade 32, respectively. Then, the screw 30 passes through the circular blade upper cover 31, the circular blade 32, the blade feeding rod 12 and the U-shaped washer 34, and is then screwed to the nut 35. When the blade fixing wheel 33 is to be rotated, only the nut 35 has to be loosened. The position of the cutting point of the circular blade 32 can be arbitrarily changed to any angle from 0 to 360 degrees by rotating the circular blade upper cover 31 to drive the circular blade 32. In addition, each of the blade fixing wheel 33 and the blade feeding rod 12 has backlashes 36 configured to facilitate the combination and the rotation.

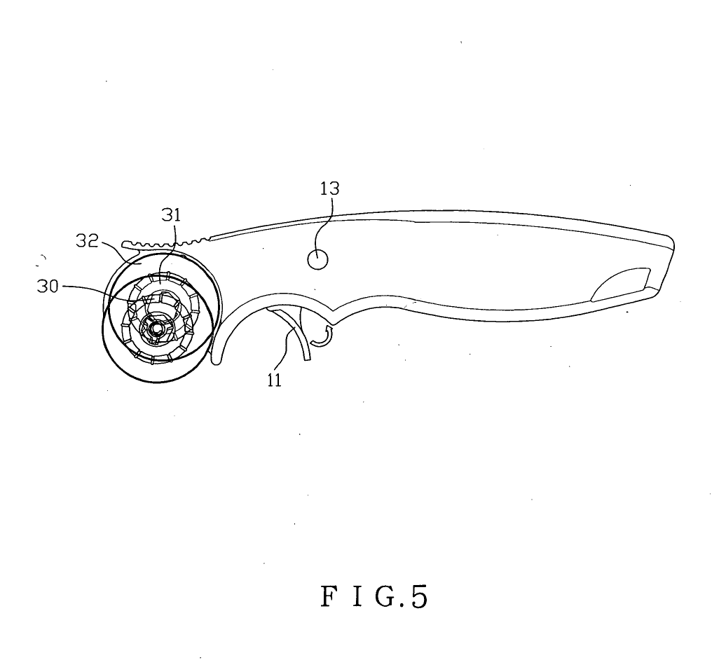

FIG. 5 shows a used state of a safety device of the invention. Pressing a blade eject button 13 while pressing the handle 11 backwards can move the blade feeding rod 12 downwards. After the blade eject button 13 is released, the blade feeding rod 12 can be locked. Because the blade feeding rod 12 and the cutting device are combined together, the circular blade 32 is in the state of exposing a blade slot 14. After the knife is used, the blade eject button 13 is pressed to release the blade feeding rod 12 so that the blade feeding rod 12 returns to its home position and the circular blade 32 is moved back to the blade slot 14 to ensure the safety in use.

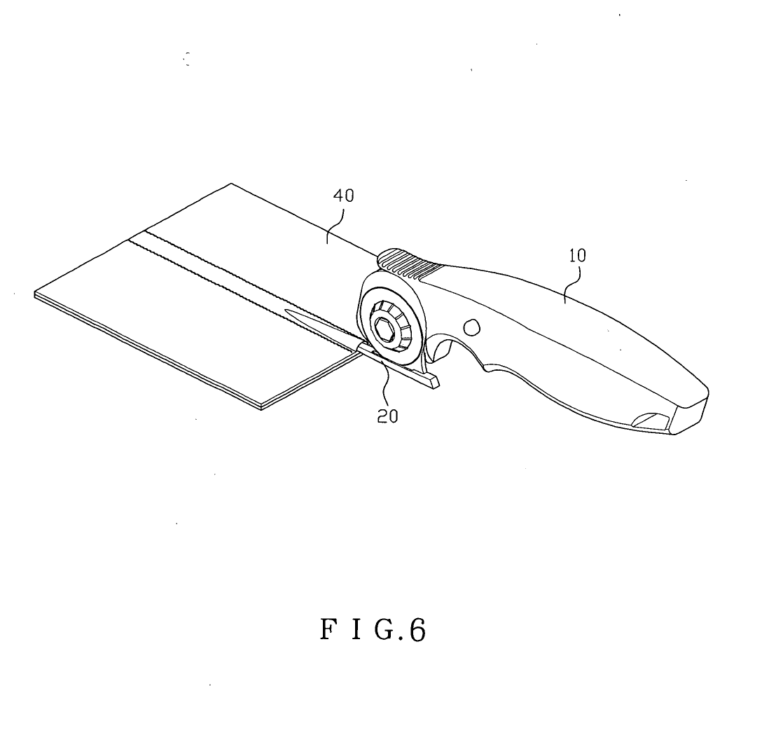

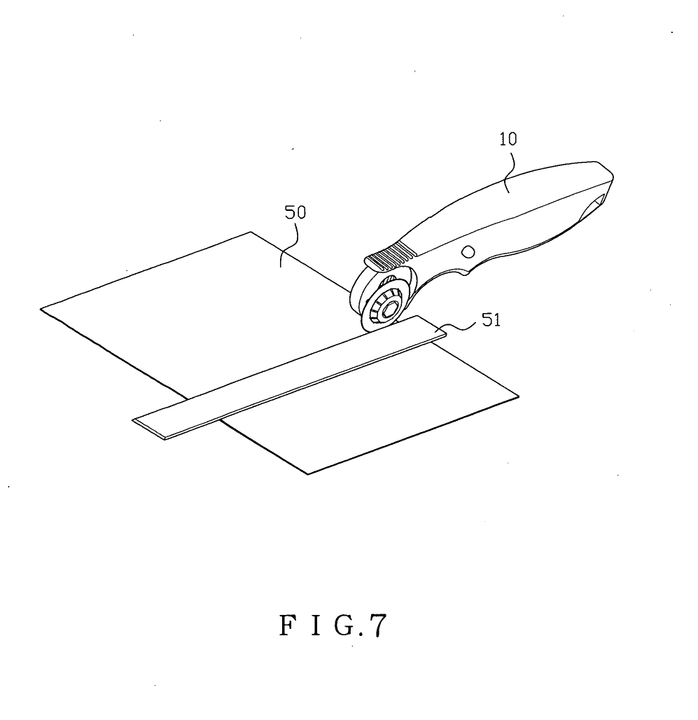

FIG. 6 shows an embodiment with the cloth-cutting guide rod. FIG. 7 shows another embodiment without the cloth-cutting guide rod. As shown in FIG. 6, the knife is combined with the right-hand cloth-cutting guide rod 20 and the front end of the right-hand cloth-cutting guide rod 20 is inserted between two suture lines of a cloth 40. The cutting slot of the cloth-cutting guide rod presses against the to-be-cut portion of the cloth 40, and the user only has to push the knife forward to perform the cutting operation to cut the cloth into two parts evenly. In addition, the cloth-cutting guide rods with different widths and lengths may be used according to the user's requirement so that various cutting states suitable for various sizes or patterns of the suture lines may be obtained. As shown in FIG. 7, the circular blade 32 and the cutting device are attached to the left side of the knife body, and the user can use his or her right hand to hold the knife to control the rotatable circular blade to cut a sheet 50 in conjunction with a straight ruler 51. Thus, the functions of the invention may be diversified.

In summary, the application range of the rotatable circular blade can be enlarged in conjunction with the cloth-cutting guide rod in the dual-use knife having the circular blade and the guide rod combined together according to the invention. In addition, the combination of the circular blade 32 and the cloth-cutting guide rod may be used and positioned on the left and right sides of the main body 10, and rotating the circular blade upper cover 31 can rotate the circular blade 32 to change the position of the cutting point of the circular blade 32 arbitrarily from 0 to 360 degrees. Thus, the lifetime of the circular blade can be lengthened. General speaking, the knife of the invention has the value and the utility in the industry.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. A dual-use knife having a rotatable circular blade and a guide rod, which may be combined together, wherein the dual-use knife is configured such that the guide rod may be attached to the rotatable circular blade, and the circular blade or a combination of the circular blade and the guide rod may be positioned and used on two sides of a knife body of the dual-use knife.

2. The dual-use knife according to claim 1, further comprising a wheel for fixing the circular blade and the guide rod, wherein the wheel can drive the circular blade to change a cutting angle from 0 to 360 degrees.

3. The dual-use knife according to claim 1, wherein the dual-use knife is configured to be equipped with different guide rods having different widths or lengths according to sizes or patterns of a to-be-cut object.
